(19) United States
(12) Patent Application Publication
(10) Pub. No.: US 2006/0072975 A1
(43) Pub. Date: Apr. 6, 2006

(54) Thread cutting tool

(75) Inventors: Josef Giessler, Muhlenbach (DE); Friedrich Schwarz, Schwanau (DE); Roland Heiler, Rimbach (DE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/236,851

(22) Filed: Sep. 28, 2005

(30) Foreign Application Priority Data
Sep. 29, 2004 (DE) 10 2004 047 839.2

(51) Int. Cl. B23G 5/06

(52) U.S. Cl. 408/222

(57) ABSTRACT

The present invention relates to a thread cutting tool with a shank and a cutting part, the cutting part having several cutting lands (3) with interjacent flutes and the cutting lands (3) having a starting taper (3a) and a guide part adjoining same. In order to produce a thread cutting tool with the features named at the outset which experiences less wear and must be reground less often than conventional threadd cutting tools of the type described previously, it is proposed according to the invention that the cutting teeth (5) have a chamfer (6) or rounded area (7) at their corners.

The present invention relates to a thread cutting tool with a shank and a cutting part, the cutting part having several cutting lands with interjacent flutes and the cutting lands each having a guide section and a starting taper. Typically, corresponding thread cutting tools have three to four cutting lands that are separated from one another by the same number of interjacent flutes. The front section of the threaded cutter is tapered, i.e. the height of the cutting teeth decreases continuously towards the tip. In the guide part, all the teeth have the same profile which corresponds exactly to the desired threaded profile. It is understood that the teeth of adjacent inserts are somewhat displaced relative to one another according to the thread pitch and that the individual teeth, insofar as they extend in the peripheral direction over the width of a cutting land, also follow the thread pitch.

The cutting lands can be aligned either essentially parallel to the axis or, as with a drill, have an angle of twist. In a section containing the axis through a cutting land or through the individual teeth of a cutting land, the latter have essentially a trapezoidal profile, the teeth in the starting taper being able to deviate from this trapezoidal shape, as the tooth height increases continuously from the tip of the thread cutting tool to the guide part, with the result that the enveloping surface of the tooth caps or outer tooth surfaces in the starting taper corresponds approximately to a cone or ellipsoid and thus in the starting taper the height of each individual tooth also increases in axial direction from the tip in the direction of the guide part. In axial longitudinal section through such a tooth in the starting taper, a slight deviation from the otherwise trapezoidal profile of the cutting teeth therefore results, as the upper short side of this “trapezoidal profile” does not run exactly parallel to the underside, but is inclined by an angle of e.g. 5-20° vis-à-vis the underside of the trapezium which corresponds to the thread core diameter.

To produce corresponding threads, a core hole is first pre-bored into which a corresponding threaded cutter is then “screwed”. In the starting taper of a thread, the teeth first cut only the radially inner section and with increasing tooth height in the direction of the guide section, the teeth then following increasingly cut more material out in these already previously cut threads, until finally the required thread depth or thread height is achieved.

The adjoining guide part essentially sees to it that as cutting of the thread continues a constant thread height and a constant thread pitch are ensured and the axial alignment of the thread cutter is also retained.

The chip-cutting capacity during the cutting of the threads is accordingly produced exclusively by the cutting teeth in the starting taper.

The teeth in the starting taper therefore become worn relatively quickly, which requires a correspondingly frequent regrinding of the teeth.

Compared with this state of the art, the object of the present invention is to create a thread cutting tool with the features named at the outset which experiences less wear and must be reground less often than conventional thread cutting tools of the type described above.

This object is achieved in that at least some of the cutting teeth and preferably all the cutting teeth in the starting taper have a chamfer or slope or round area at their outer corners. This means that, in a longitudinal section containing the axis of the thread cutting tool, deviating from the almost trapezoidal shape, the tooth profile is clearly chamfered or rounded at the top corners of the trapezium.

The width of such a chamfer or the radius of the rounded area of these corner areas should be at least approximately a fifth of the outer thread width. By “outer thread width” is meant the measured width (in axial direction) of the thread on the outside of the thread which, relative to the trapezoidal profile of the teeth in the guide part, corresponds to the short side of this trapezoidal profile. Relative to the thread height (axial distance between equivalent points of directly successive threads), the width of the chamfer or the radius of the rounded area should be at least approximately one fiftieth of this thread height or thread pitch (equal to the axial feed per revolution of the thread cutting tool or of a corresponding screw).

The maximum width of the chamfer or the maximum radius of the rounded area should not exceed five to ten times the minimum width just defined, i.e. related specifically to the outer thread width, be at most approximately half of same or alternatively at most a fifth of the thread pitch (expressed in axial feed per revolution).

The chamfer surface preferably extends with constant width over the whole peripheral length of a cutting tooth, the chamfer width also being able to increase in peripheral direction, starting from the cutting edge of a cutting tooth, in order to produce a larger clearance angle.

The same applies to a rounded area. The incline of the chamfer relative to the adjacent tooth flank and the adjacent tooth cap (equals upper trapezium side) is preferably symmetrical, i.e. the chamfer surface forms with the adjacent tooth flank the same angle as with the adjacent tooth cap. In other words, the chamfer surface runs perpendicular to an angle bisector between tooth flank and tooth cap.

A corresponding rounded area preferably passes smoothly and without bending into the adjacent tooth flank and the adjacent tooth cap.

In the case of the thread cutting tool according to the invention, the number of teeth in the starting taper should be at least one for each cutting land, preferably at least 2 or 3 or more teeth form the starting taper.

However, the number of teeth in the starting taper also depends on the size of the thread and in particular on the thread height, in order to keep the thickness of the chips produced by each of the teeth within specific preset limits.

Further advantages, features and application areas of the present invention become clear with the help of the following description of a preferred version and the associated figures. There are shown in:

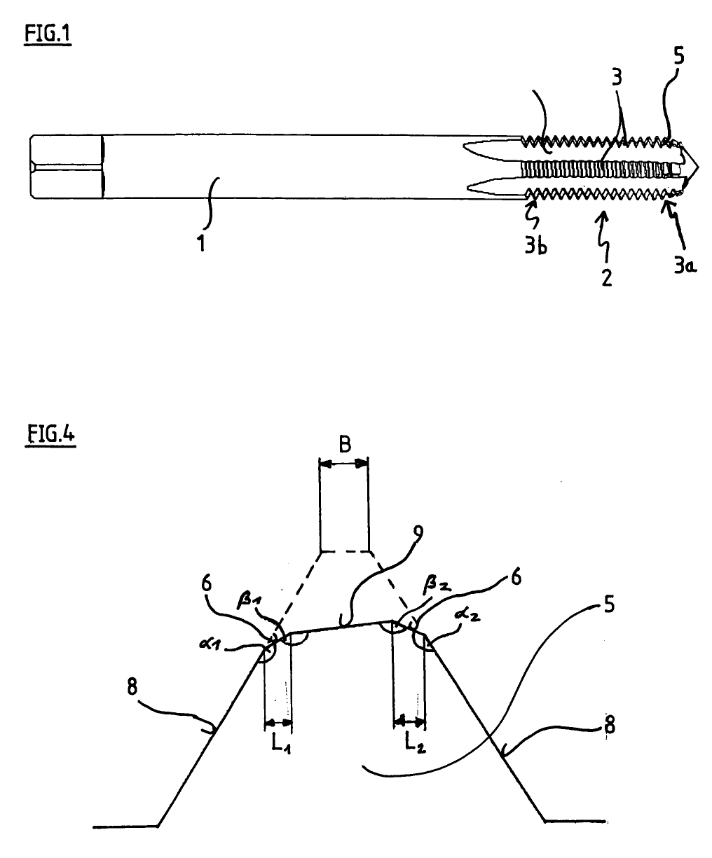

FIG. 1 a side view of a thread cutting tool,

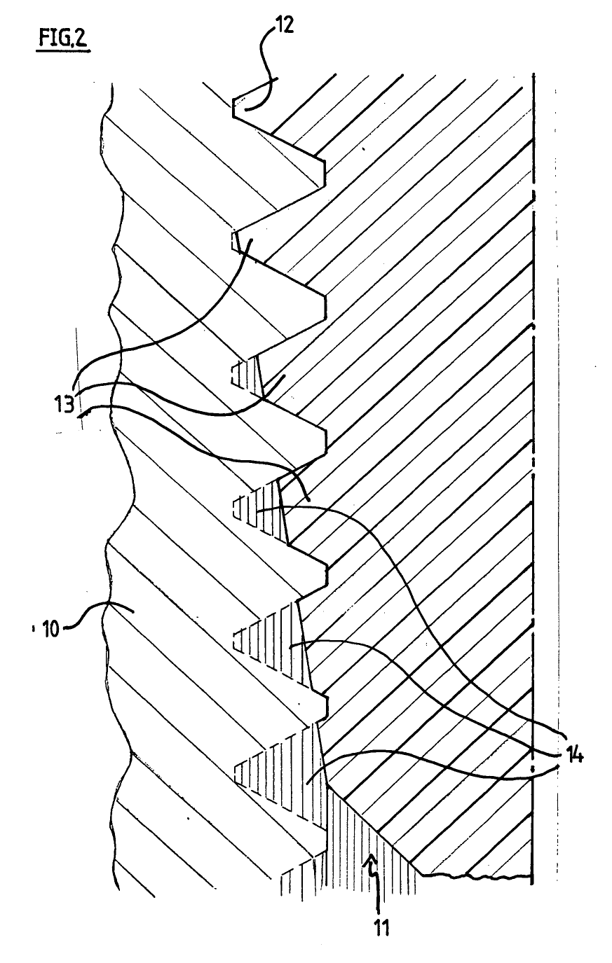

FIG. 2 an axial longitudinal section through a thread cutting tool according to the state of the art engaged in a schematically drawn workpiece,

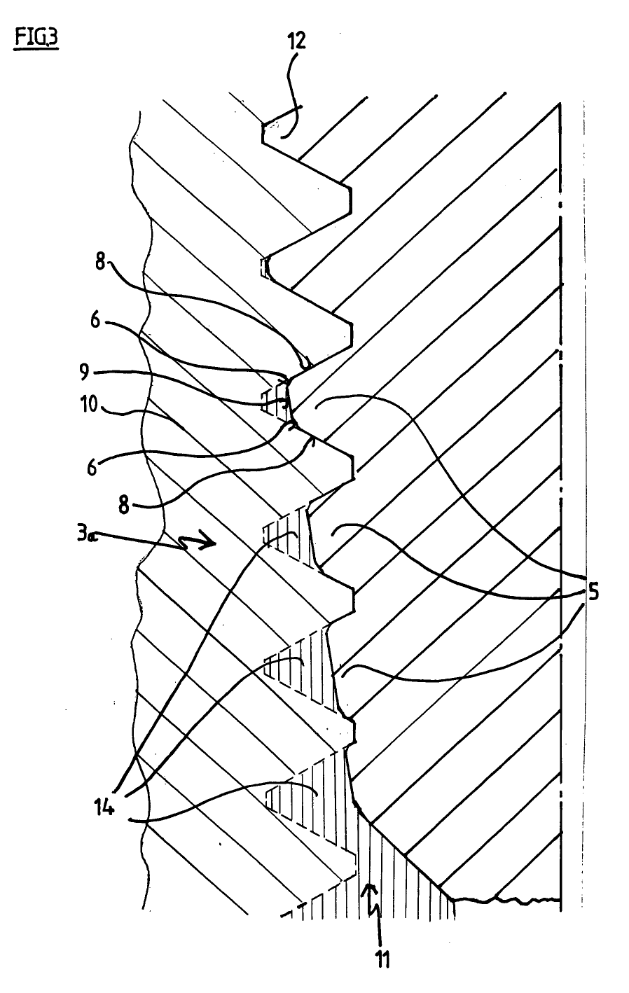

FIG. 3 a view analogous to FIG. 2, but with a thread cutting tool according to the invention,

FIG. 4 a schematic representation of an individual cutting tooth according to the present invention,

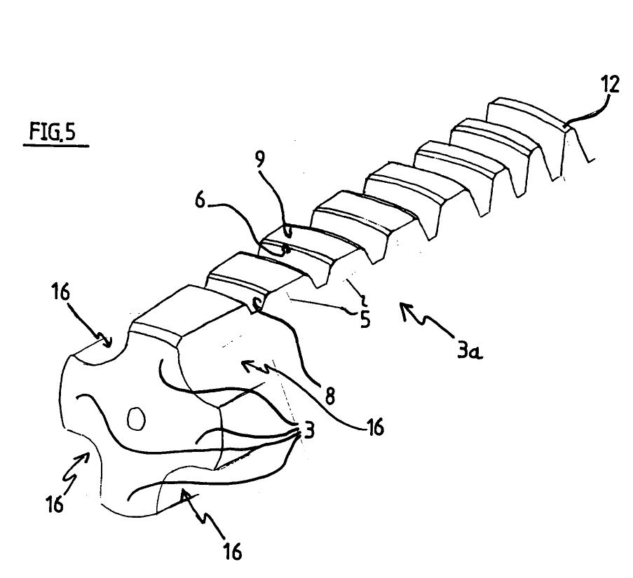

FIG. 5 a truncated three-dimensional view of the thread cutting tool from FIG. 3,

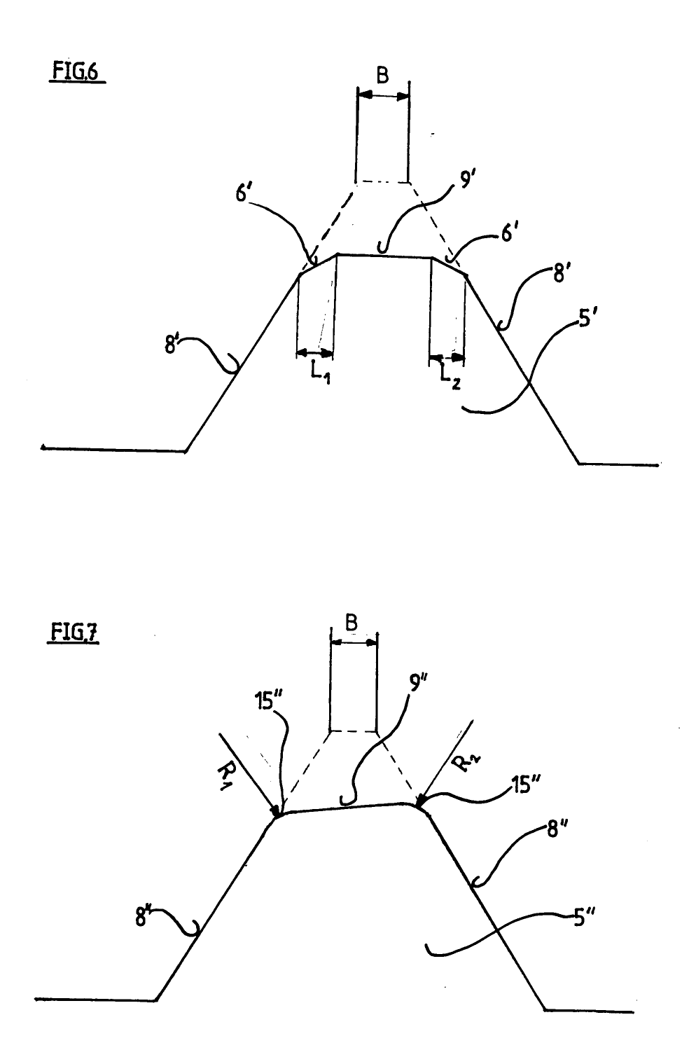

FIG. 6 a representation of an alternative cutting tooth shape according to the present invention and

FIG. 7 a further alternative cutting tooth shape with rounded corner areas.

There can be seen in FIG. 1 a thread cutting tool which is composed of a shank 1 and a cutting part 2, the cutting part in turn being composed of several cutting lands 3 and interjacently arranged flutes. In the version shown here, the cutting lands run parallel to the axis and e.g. three or four cutting lands 3 are distributed along the periphery. In the case of other versions, the cutting lands and flutes could however also run spirally. Each cutting land 3 is in turn composed of a group of cutting teeth, adjoining the shank 1, which form the so-called guide part 3b, and of front cutting teeth 5 which form the so-called starting taper or gate 3a. In the starting taper, the thread cutting tool tapers towards the tip, i.e. the enveloping surface of the cutting teeth, which would be a cylinder in the guide part, is conically or elliptically tapered towards the tip in the starting taper.

The features according to the invention cannot be seen in the representation of FIG. 1, but are visible only in the enlargement according to FIG. 3. FIG. 2 corresponds to an axial longitudinal section through a cutting land of a thread cutting tool as shown in FIG. 1, engaged in a likewise schematically drawn workpiece. The workpiece 10 has a core bore 11 into which the thread cutting tool is sunk and screwed. The individual teeth 12, 13 successively cut out increasingly deeper areas of the trapezoidal tooth profile. In the shown starting taper, the final (but not yet cut) thread profile is indicated by a dashed line. The areas 14 still to be cut of the workpiece 10 are hatched with vertical lines.

As can be seen, each individual cutting tooth 12, 13 has an almost trapezoidal profile, the height of the trapezium increasing continuously from the tip in the direction of the guide part, until finally the full profile of a thread is achieved, as the teeth 12 have in the guide part. A degree of deviation from the trapezoidal profile occurs only because the radius of the cutting tool in the starting taper tapers from the guide part towards the tip of the tool and because this shape can be best produced by grinding along a for example conical or elliptical enveloping surface. But it would be equally possible to give each individual tooth in the starting taper an exact trapezoidal profile and to allow the height of this trapezoidal profile to increase stepwise from tooth to tooth (from the tip to the guide part).

FIG. 3 shows a similar axial cut to FIG. 2, but for the tooth profile according to the invention. As can be seen, in this case the teeth 5 in the starting taper 3a deviate somewhat in their profile shape from the mentioned trapezoidal shape in as much as the upper outer corners of the trapezoidal profile have a slope 6, which is also called chamfer in specialist language. Here also, the thread profile to be finally produced is again drawn in dashed lines and the material 14 to be cut of the workpiece 10 hatched vertically and the cut profile area in each case corresponds to the profile of the individual teeth.

FIG. 4 shows an enlarged cross-section of one of the teeth 5 in the starting taper. The axial length of the two chamfers 6 is designated L1 and L2. Relative to the width B of the thread at the outermost periphery of the thread, which is likewise drawn in FIG. 4, the axial dimensions of the chamfers or slopes 6 should be no more than half. The chamfer surface should form approximately the same angle with the adjacent tooth flank 8 and the tooth cap 9 respectively, i.e. the drawn-in angles α1 and β1 are approximately the same, just like the angles α2 and β2 (which however in turn differ from α1 and β1, as the tooth cap 9 runs inclined relative to the axis of the tool).

A truncated three-dimensional view of the version of the thread cutting tool shown in FIGS. 3 and 4 is shown in FIG. 5. The course of the chamfers 6 along the periphery of the cutting teeth 5 lying in the area of the gate 3a can be clearly seen. There can be seen between the four cutting lands 3 arranged distributed over the periphery of the tool the four flutes 16 which in the shown version have a course parallel to the axis of rotation.

FIG. 6 shows a variant in which the individual teeth 5′ in the starting taper are tapered stepwise, i.e. each individual tooth has a cap surface 9′ parallel to the axis. For the axial length L₁, L₂ of the chamfers 6′, the same applies as in the case of the embodiment of FIG. 4. The 4 angles α1, β1, α2 and β2, not drawn here, would without exception be identical in this case, at any rate in the preferred version of the invention.

FIG. 7 finally shows a tooth profile in which, instead of a chamfer or a slope, a rounded area 15″ has been carried out. The rounded area radii R1, R2 are preferably identical or at least of the same magnitude and the value of the radii R1, R2 is preferably no more than half of the dimension B. This dimension B, i.e. the width measured in axial direction of the thread at the outermost periphery of the thread, is in turn, expressed in the axial distance between equivalent points of two consecutive thread sections, approximately a fifth to a tenth compared with the thread pitch. Consequently, the maximum axial length of the chamfer or the maximum radius of the rounded area can also be related to this thread pitch and is then at most a tenth of the thread pitch.

The minimum value of the axial length of the chamfers or radii of the rounded areas should be approximately a fifth of the maximum dimensions, i.e. is approximately one fiftieth of the thread pitch and approximately a tenth of the outer axial width of the thread.

For the purposes of the original disclosure, it is pointed out that all features revealed to a person skilled in the art by the present description, the drawings and the claims, even if described specifically only in connection with certain further features, can be combined both individually and in any desired configurations with others of the features or groups of features disclosed here, unless this has been expressly ruled out or technical conditions render such combinations impossible or pointless. A comprehensive, explicit representation of all conceivable combinations of features is dispensed with here merely for the sake of brevity and readability of the description.

1. Thread cutting tool with a shank and a cutting part, the cutting part having several cutting lands with interjacent flutes and the cutting lands each having a starting taper and a guide section adjoining same, characterized in that in the starting taper the cutting teeth have a chamfer or rounded area at their corners.

2. Thread cutting tool according to claim 1, characterized in that the width of the chamfer or the radius (r) of the rounded areas is at most half of the outer thread width.

3. Threaded cutter according to claim 1, characterized in that the width of the chamfer or the radius (r) of the rounded area is at least a fifth of the outer thread width.

4. Thread cutting tool according to claim 1, characterized in that the chamfer surface runs perpendicular to the angle bisector between tooth flank and tooth cap.

5. Thread cutting tool according to claim 1, characterized in that in each case the rounded area passes smoothly into the tooth flank and the tooth cap.

6. Thread cutting tool according to claim 1, characterized in that the starting taper provided with a chamfer or rounded area extends over at least one, preferably at least two or three consecutive teeth.

7. Thread cutting tool according to claim 1, characterized in that in the starting taper the tooth cap of the cutting teeth has an incline between 3° and 20° relative to the axis of the cutting tool.

8. Thread cutting tool according to claim 1, characterized in that in the starting taper the tooth cap of the cutting teeth runs parallel or concentric to the axis.
